(19) United States
(12) Patent Application Publication
(10) Pub. No.: US 2015/0293418 A1
(43) Pub. Date: Oct. 15, 2015

(54) ELECTRO-OPTICAL DEVICE, OPTICAL UNIT, AND ELECTRONIC APPARATUS

(71) Applicant: SEIKO EPSON CORPORATION, Tokyo (JP)

(72) Inventor: Minoru MORIWAKI, Matsumoto-shi (JP)

(21) Appl. No.: 14/686,511

(22) Filed: Apr. 14, 2015

(30) Foreign Application Priority Data
Apr. 14, 2014 (JP) 2014-082546

(51) Int. Cl. G02F 1/1362; H04N 9/31; G02F 1/1343; G02F 1/1368; G02F 1/1335

(52) U.S. Cl. CPC G02F 1/136209; G02F 1/1368; G02F 1/133528; G02F 1/134309; H04N 9/3105; H04N 9/3167

(57) ABSTRACT

An electro-optical device, including: a substrate; a pixel electrode; a pixel switching element which is disposed between the substrate and the pixel electrode; a first light shielding film which is disposed between the pixel switching element and the pixel electrode, and extends in one direction among the first direction and the second direction; and a second light shielding film which is disposed between the pixel switching element and the pixel electrode, and extends in the other direction among the first direction and the second direction. A pixel opening portion is defined by an outer edge of the first light shielding film and an outer edge of the second light shielding film.

### BACKGROUND

1. Technical Field

The present invention relates to an electro-optical device, an optical unit and an electronic apparatus which have the electro-optical device mounted thereon.

2. Related Art

An active driving type liquid crystal device, which is used as an optical modulating unit (light valve) of a liquid crystal projector, is an example of an electro-optical device. The active driving type liquid crystal device includes an element substrate which is provided with a thin film transistor (TFT), an opposing substrate which is provided with a common electrode, and a liquid crystal which is disposed between the element substrate and the opposing substrate. On a base member of the element substrate, a scanning line, the TFT, a signal line, a pixel electrode and the like, are provided in order. Furthermore, a pixel opening portion, which transmits light by a constituent element (light shielding film) having light shielding properties which is formed on the element substrate or the opposing substrate, is defined.

In the liquid crystal projector, a pair of polarizing elements which is disposed in a cross-nicol state, is disposed on a light-incidence side and a light-emitting side of the liquid crystal device. The light which is polarized by the polarizing elements disposed on the light-incidence side passes through the polarizing elements in the liquid crystal device (pixel opening portion) and on the light-emitting side, and becomes image light which displays a predetermined image.

In the liquid crystal projector in this configuration, the light shielding film which defines the pixel opening portion is configured of a light shielding material having light reflective properties, such as aluminum, and when an outer edge of the light shielding film is disposed in a direction which intersects a polarizing direction of the polarizing elements, light which is incident on the pixel opening portion and passes through the outer edge is polarized in a direction which is different from a direction in which the light is originally to be polarized, and a polarization state changes. Furthermore, reflected light which is reflected on an end surface of the outer edge of the light shielding film among rays of light which are incident on the pixel opening portion is polarized in a direction which is different from a direction in which the light is originally to be polarized, and the polarization state changes. Therefore, when the outer edge of the light shielding film is disposed in the direction which intersects the polarizing direction of the polarizing elements, the polarization state of a part of the light which is incident on the pixel opening portion changes, the light becomes leakage light, and display contrast deteriorates.

For this reason, in JP-A-2010-250005, negative influence (deterioration of display contrast) on display when the outer edge of the light shielding film is disposed in the direction which intersects the polarizing direction, is suppressed by covering the light shielding film having light reflective properties with the light shielding material having lower light reflectivity than that of the light shielding film, and by reducing reflection of the light on the end surface of the outer edge of the light shielding film.

In JP-A-2010-160308, the pixel opening portion is defined by the scanning line and the signal line which extend along the polarizing direction of the polarizing elements so that the outer edge of the light shielding film which defines the pixel opening portion is not disposed in the direction which intersects the polarizing direction of the polarizing elements.

In JP-A-2010-250005, there is a problem that it is difficult to completely suppress reflection of the light by the light shielding material having low light reflectivity, slight reflection of the light is generated, and it is difficult to completely suppress deterioration of display contrast.

In JP-A-2010-160308, the scanning line and the signal line which define the pixel opening portion are disposed nipping the TFT on the substrate. In other words, since two light shielding films which define the pixel opening portion are disposed to be apart from each other while nipping the TFT, for example, compared to a case where the two light shielding films which define the pixel opening portion are disposed to be close to each other, there is a problem that light shielding properties deteriorate, and light leakage is likely to be generated.

### SUMMARY

The invention can be realized in the following forms or application examples.

### Application Example 1

According to this application example, there is provided an electro-optical device which is disposed between a first polarizing element which polarizes light in a first direction, and a second polarizing element which polarizes the light in a second direction which intersects the first direction, including: a substrate; a pixel electrode; a pixel switching element which is disposed between the substrate and the pixel electrode; a first light shielding film which is disposed between the pixel switching element and the pixel electrode, and extends in one direction among the first direction and the second direction; and a second light shielding film which is disposed between the pixel switching element and the pixel electrode, and extends in the other direction among the first direction and the second direction. A pixel opening portion is defined by an outer edge of the first light shielding film and an outer edge of the second light shielding film.

In this case, the pixel opening portion is defined by the outer edge of the first light shielding film which extends in one direction among the first direction and the second direction, and the outer edge of the second light shielding film which extends in the other direction among the first direction and the second direction. The outer edge of the light shielding film which defines the pixel opening portion is disposed along the polarizing direction of the light which is polarized by the first polarizing element and the second polarizing element, and is not disposed in a direction which intersects the polarizing direction of the light. For this reason, a polarization state of the light which passes through the pixel opening portion does not change, and thus, it is possible to suppress deterioration (leakage light) of display contrast due to the change of the polarization state. In other words, it is possible to suppress generation of slight leakage of the light, which is a problem of the known technology (JP-A-2010-250005)

Two light shielding films (first light shielding film and second light shielding film) which define the pixel opening portion is disposed between the pixel switching element (TFT) and the pixel electrode. Compared to the known technology (JP-A-2010-160308) in which the two light shielding films are disposed to be apart from each other while nipping the pixel switching element (TFT), since the two light shielding films (first light shielding film and second light shielding film) are disposed to be close to each other, light shielding properties are improved, and a concern about generation of light leakage is reduced.

Therefore, in this case, it is possible to suppress deterioration of display contrast compared to the known technology, and to provide high display quality.

### Application Example 2

According to this application example, there is provided an electro-optical device which is disposed between a first polarizing element which polarizes light in a first direction, and a second polarizing element which polarizes the light in a second direction which intersects the first direction, including: a substrate; a pixel electrode; a pixel switching element which is disposed between the substrate and the pixel electrode; a first light shielding film which is disposed between the pixel switching element and the pixel electrode, and extends in one direction among the first direction and the second direction; a second light shielding film which is disposed between the pixel switching element and the pixel electrode, and extends in the other direction among the first direction and the second direction; a first conducting film having light shielding properties which is provided on the same layer as the first light shielding film; and a second conducting film having light shielding properties which is provided on the same layer as the second light shielding film. A pixel opening portion is defined by an outer edge of the first light shielding film, an outer edge of the second light shielding film, and at least one outer edge of the first conducting film and the second conducting film.

In this case, the pixel opening portion is defined by the outer edge of the first light shielding film which extends in one direction among the first direction and the second direction, the outer edge of the second light shielding film which extends in the other direction among the first direction and the second direction, and at least one outer edge of the first conducting film and the second conducting film. The outer edge of the light shielding film which defines the pixel opening portion is disposed along the polarizing direction of the light which is polarized by the first polarizing element and the second polarizing element, and is not disposed in the direction which intersects the polarizing direction of the light. Furthermore, as at least one outer edge of the first conducting film and the second conducting film which defines the pixel opening portion is disposed along the polarizing direction of the light, the polarization state of the light which passes through the pixel opening portion does not change, and thus, it is possible to suppress deterioration (leakage light) of display contrast due to the change of the polarization state. In other words, it is possible to suppress generation of slight leakage of the light, which is a problem of the known technology (JP-A-2010-250005).

In this case, the light shielding films (first light shielding film, second light shielding film, first conducting film, and second conducting film) which define the pixel opening portion are disposed between the pixel switching element (TFT) and the pixel electrode. Compared to the known technology (JP-A-2010-160308) in which the light shielding films which define the pixel opening portion are disposed to be apart from each other while nipping the pixel switching element (TFT), since the light shielding films which define the pixel opening portion are disposed close to each other, light shielding properties are improved, and a concern about generation of light leakage is reduced.

Therefore, in this case, compared to the known technology, it is possible to suppress deterioration of display contrast, and to provide high display quality.

Furthermore, it is possible to enhance a degree of freedom of wiring as at least one of the first conducting film and the second conducting film is used in a relay electrode which electrically connects wirings disposed on a plurality of layers.

### Application Example 3

In the electro-optical device according to the application example, it is preferable that a material which constitutes the first light shielding film and the second light shielding film be aluminum or a conductive material including aluminum.

In this case, aluminum or the conductive material including aluminum has excellent light shielding properties and less conductivity, compared to a conductive material having a high melting point, such as titanium nitride. Therefore, light shielding properties of the light shielding films (first light shielding film and second light shielding film) which define the pixel opening portion are improved, and thus, it is possible to reduce resistance of the light shielding films (first light shielding film and second light shielding film).

### Application Example 4

In the electro-optical device according to the application example, it is preferable that a signal line be provided which extends in one direction among the first direction and the second direction between the pixel switching element and the pixel electrode. It is preferable that the first light shielding film be disposed on a layer between a layer on which the signal line is formed and a layer on which the pixel electrode is formed. It is preferable that the second light shielding film be disposed on a layer between the layer on which the first light shielding layer is formed and the layer on which the pixel electrode is formed.

In this case, the two light shielding films (first light shielding film and second light shielding film) are disposed between the layer on which the signal line is formed and the layer on which the pixel electrode is formed. Compared to the known technology (JP-A-2010-160308) in which the two light shielding films are disposed to be apart from each other while nipping the pixel switching element (TFT), since the two light shielding films (first light shielding film and second light shielding film) are disposed to be close to each other, light shielding properties are improved, and a concern about generation of light leakage is reduced.

Furthermore, the first light shielding film extends in the same direction as the signal line, and is disposed on a side closer to the signal line than the second light shielding film. As the first light shielding film is disposed to cover the signal line between the signal line and the pixel electrode, it is possible to reduce influence of an electric field of the signal line with respect to the pixel electrode.

### Application Example 5

In the electro-optical device according to the application example, it is preferable that the first light shielding film and the second light shielding film be wirings to which a fixed potential is supplied.

In this case, when the first light shielding film and the second light shielding film are wirings to which the fixed potential is supplied, and the first light shielding film and the second light shielding film supply the fixed potential, influence of the electric field of the signal line with respect to the pixel electrode, that is, coupling between the signal line and the pixel electrode can be reduced. Therefore, it is possible to reduce potential variation of the pixel electrode due to the electric field of the signal line, and improve display quality.

### Application Example 6

In the electro-optical device according to the application example, it is preferable that the outer edge of the first light shielding film and the outer edge of the second light shielding film which define the pixel opening portion be straight lines.

In this case, for example, when the outer edge of the light shielding film which defines the pixel opening portion has a part which is not a straight line, the outer edge of the part which is not a straight line is disposed in the direction which intersects the polarizing direction of the light, the polarization state of the light which passes through the pixel opening portion changes, and display contrast deteriorates. Since the outer edge of the light shielding film which defines the pixel opening portion is a straight line along the polarizing direction of the light, the polarization state of the light which passes through the pixel opening portion does not change, and thus, it is possible to suppress deterioration (leakage light) of display contrast due to the change of the polarization state of the light.

### Application Example 7

According to this application example, there is provided an optical unit, including: a first polarizing element which polarizes light in a first direction; a second polarizing element which polarizes the light in a second direction which intersects the first direction; the electro-optical device according to above-described application examples which is disposed between the first polarizing element and the second polarizing element; and a light synthesizing optical system which synthesizes and emits the light which is emitted from the plurality of electro-optical devices.

In this case, compared to the known technology, the electro-optical device according to the above-described application example suppresses deterioration of display contrast, and provides high display quality. Therefore, the optical unit which includes the electro-optical device according to the above-described application example also provides high display quality.

### Application Example 8

According to this application example, there is provided an electronic apparatus, including: the electro-optical device according to the above-described application example; and the optical unit according to the above-described application example.

In this case, compared to the known technology, the electro-optical device according to the above-described application example suppresses deterioration of display contrast, and provides high display quality. Furthermore, the optical unit which includes the electro-optical device according to the above-described application example also provides high display quality. Therefore, in the electronic apparatus which includes the electro-optical device according to the above-described application example and the optical unit according to the above-described application example, high display quality is provided.

For example, by employing the electro-optical device according to the above-described application example in the electronic apparatus, such as a projection type display apparatus, a projection type head-up display (HUD), a direct viewing type head-mounted display (HMD), an electronic book, a personal computer, a digital still camera, a liquid crystal television, a view finder type or a monitor direct viewing type video recorder, a car navigation system, an information terminal apparatus including a POS, and an electronic organizer, it is possible to realize high display quality.

For example, by employing the optical unit according to the above-described application example in the electronic apparatus, such as the projection type display apparatus, or the projection type head-up display (HUD), it is possible to realize high display quality.

### BRIEF DESCRIPTION OF THE DRAWINGS

The invention will be described with reference to the accompanying drawings, wherein like numbers reference like elements.

FIG. 1 is a schematic view illustrating a configuration of a projection type display apparatus provided with a liquid crystal device.

FIG. 2 is a schematic plan view illustrating a configuration of the liquid crystal device.

FIG. 3 is a schematic cross-sectional view of the liquid crystal device along line III-III in FIG. 2.

FIG. 4 is an equivalent circuit diagram illustrating an electric configuration of the liquid crystal device.

FIG. 5 is a schematic plan view illustrating a configuration of an element substrate.

FIG. 6 is a schematic plan view illustrating a configuration of the element substrate.

FIG. 7 is a schematic plan view illustrating a configuration of the element substrate.

FIG. 8 is a schematic plan view illustrating a configuration of the element substrate.

FIG. 9 is a schematic plan view illustrating a configuration of the element substrate.

FIG. 10 is a schematic cross-sectional view of the element substrate along line X-X in FIGS. 5 to 9.

### DESCRIPTION OF EXEMPLARY EMBODIMENTS

Hereinafter, an embodiment of the invention will be described with reference to the drawings. The embodiment illustrates an aspect of the invention, the invention is not limited thereto, and the embodiment can be arbitrarily changed within a range of a technical concept of the invention. In addition, in each following drawing, in order to make each layer or each part have a certain size to be recognizable on the drawings, a scale of each layer or each part is different from a real scale.

### Embodiment

### Overview of Projection Type Display Apparatus

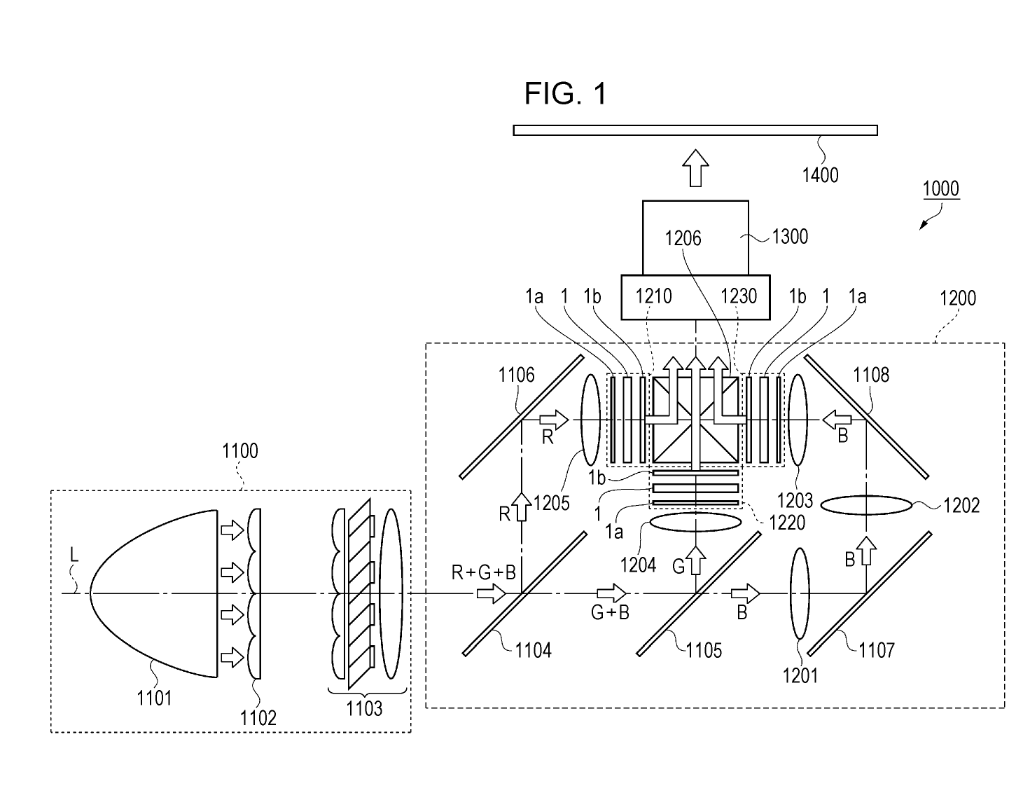

First, a projection type display apparatus which is an example of an “electronic apparatus” in the invention will be described with reference to FIG. 1. FIG. 1 is a schematic view illustrating a configuration of the projection type display apparatus provided with a liquid crystal device according to the embodiment.

As illustrated in FIG. 1, a projection type display apparatus 1000 is configured of a polarization lighting device 1100 which is disposed along a system optical axis L, an optical unit 1200, and a projection optical system (projection lens 1300).

The polarization lighting device 1100 is schematically configured of a lamp unit 1101 as a light source which is made of white light source, such as a ultrahigh pressure mercury lamp or a halogen lamp, an integrator lens 1102, and a polarization conversion element 1103.

The optical unit 1200 is provided with two dichroic mirrors 1104 and 1105 as light separating elements, three reflecting mirrors 1106, 1107, and 1108, five relay lenses 1201, 1202, 1203, 1204, and 1205, three transmission type liquid crystal light valves 1210, 1220, and 1230, and a cross dichroic prism 1206.

The dichroic mirror 1104 reflects red light (R), and makes green light (G) and blue light (B) transmit, among polarization luminous fluxes emitted from the polarization lighting device 1100. The other dichroic mirror 1105 reflects the green light (G) which is transmitted by the dichroic mirror 1104 and makes the blue light (b) transmit.

The red light (R) which is reflected by the dichroic mirror 1104 is incident on the liquid crystal light valve 1210 via the relay lens 1205 after being reflected by the reflecting mirror 1106. The green light (G) which is reflected by the dichroic mirror 1105 is incident on the liquid crystal light valve 1220 via the relay lens 1204. The blue light (B) which is transmitted by the dichroic mirror 1105 is incident on the liquid crystal light valve 1230 via a light guiding system which is made of three relay lenses 1201, 1202, and 1203, and two reflecting mirrors 1107 and 1108.

The liquid crystal light valves 1210, 1220, and 1230 are respectively disposed to oppose incident surfaces of each color light of the cross dichroic prism 1206. The color light which is incident on the liquid crystal light valves 1210, 1220, and 1230, is modulated based on image information (image signal) and is emitted toward the cross dichroic prism 1206.

The liquid crystal light valve 1210 is configured of a liquid crystal device 1, and a pair of polarizing elements 1a and 1b which is disposed in a cross-nicol state on an incidence side and an emitting side of the color light (red light). The liquid crystal device 1 is disposed with a void (interval) between the polarizing element 1a which is disposed on the incidence side of the color light, and the polarizing element 1b which is disposed on the emitting side of the color light. Other liquid crystal light valves 1220 and 1230 also have a similar configuration.

In addition, the liquid crystal device 1 is an example of an “electro-optical device” in the invention. The polarizing element 1a is an example of a “first polarizing element” in the invention, and the polarizing element 1b is an example of a “second polarizing element” in the invention. A polarizing direction of the polarizing element 1a which is disposed on the incidence side of the color light is an example of a “first direction” in the invention. A polarizing direction of the polarizing element 1b which is disposed on the emitting side of the color light is an example of a “second direction” in the invention.

The cross dichroic prism 1206 has four rectangular prisms stuck thereto, and a dielectric multilayer film which reflects the red light and a dielectric multilayer film which reflects the blue light are formed in a cross shape on the inner surface thereof. The three rays of color light are synthesized by these dielectric multilayer films, and light which shows a color image is synthesized.

In addition, the cross dichroic prism 1206 is an example of a “light synthesizing optical system” in the invention.

The light (image light) which is synthesized by the cross dichroic prism 1206 is projected onto a screen 1400 by a projection lens 1300 which is a projection optical system, and the image is enlarged and displayed.

### Overview of Liquid Crystal Device

Next, an overview of the liquid crystal device 1 as an optical modulating unit in the projection type display apparatus 1000 will be described.

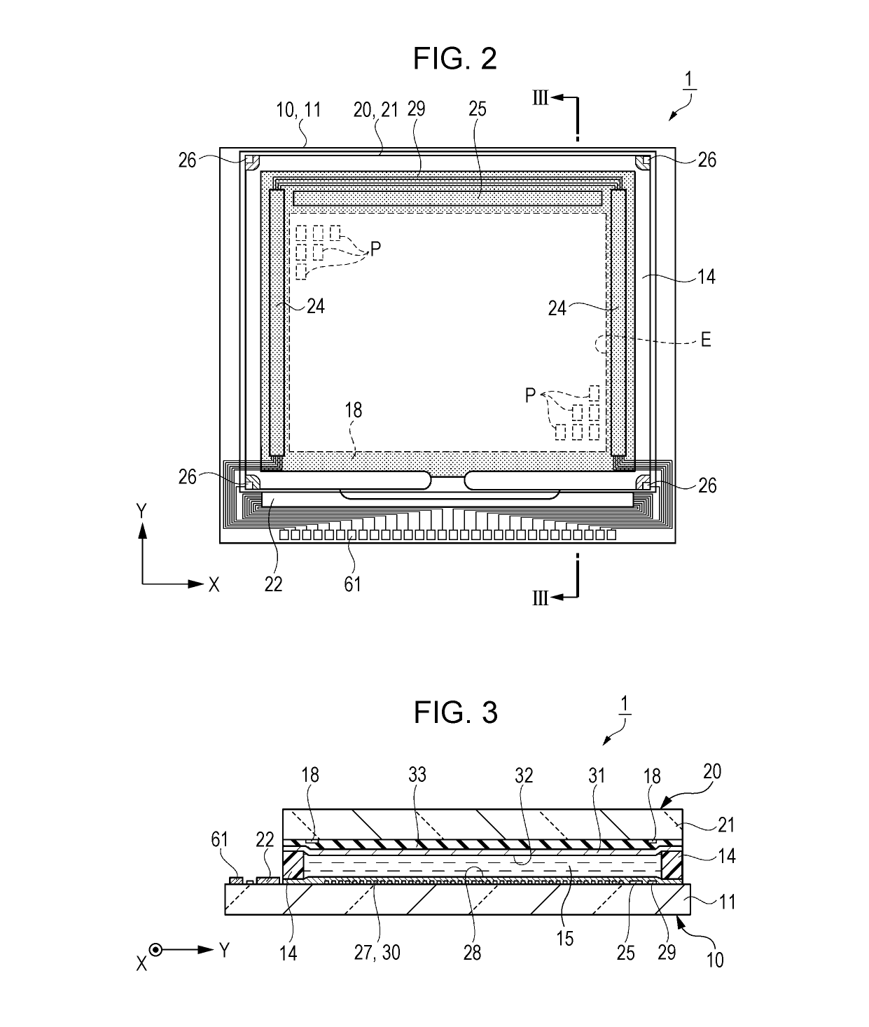

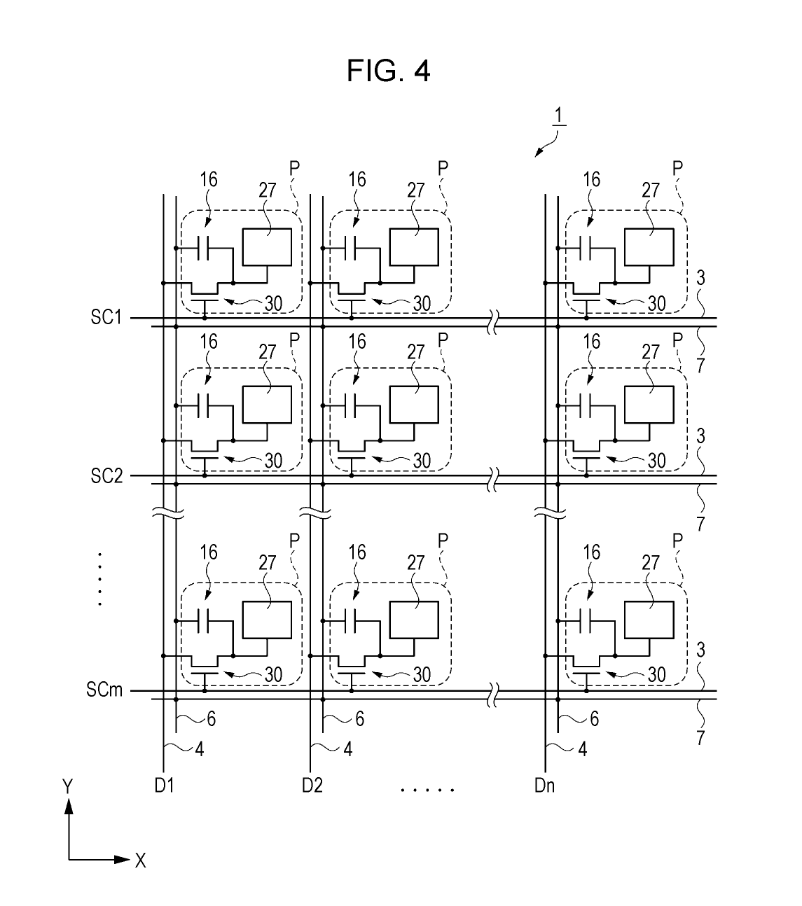

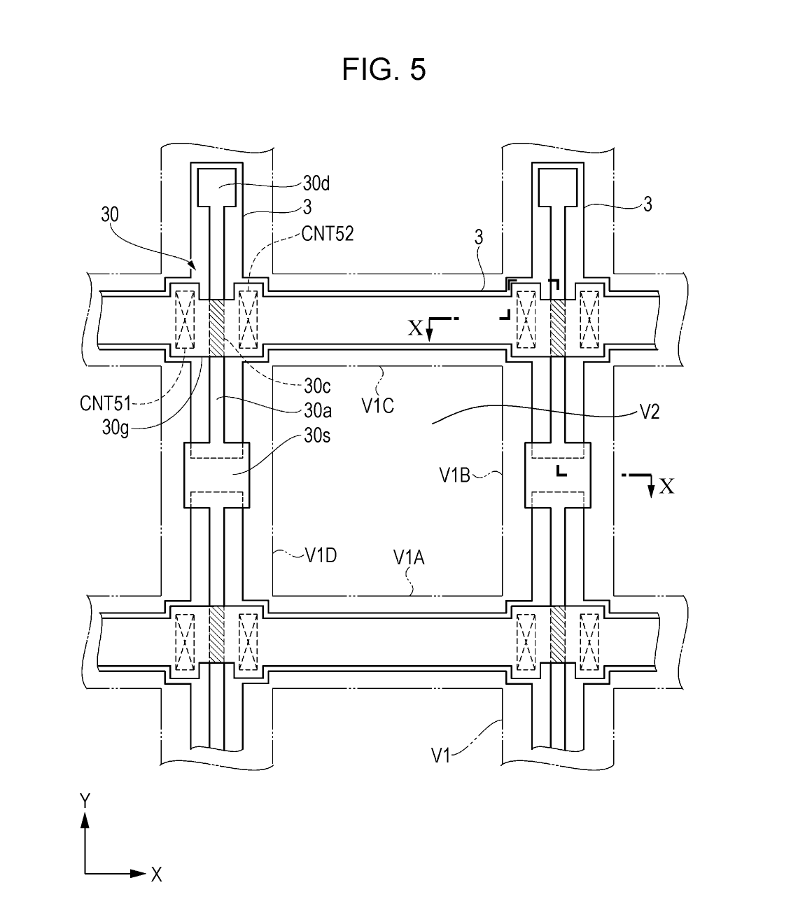

FIG. 2 is a schematic plan view illustrating a configuration of the liquid crystal device. FIG. 3 is a schematic cross-sectional view of the liquid crystal device along line III-III in FIG. 2. FIG. 4 is an equivalent circuit diagram illustrating an electric configuration of the liquid crystal device.

As illustrated in FIGS. 2 and 3, the liquid crystal device 1 includes an element substrate 10 and an opposing substrate 20 which are disposed to oppose each other, and a liquid crystal layer 15 which is pinched by this pair of substrates. In a first base member 11 which is a base member that constitutes the element substrate 10, and in a second base member 21 which is a base member that constitutes the opposing substrate 20, a transparent substrate, such as a glass substrate or a quartz substrate, is used.

In addition, the first base member 11 is an example of the “substrate” in the invention.

In the above-described liquid crystal light valves 1210, 1220, and 1230 (refer to FIG. 1), the polarizing element 1a which is disposed on the incidence side of the color light is disposed on the opposing substrate 20 side, and the polarizing element 1b which is disposed on the emitting side of the color light is disposed on the element substrate 10 side. In other words, the light (color light which is separated by the dichroic mirror 1104) emitted from the polarization lighting device 1100 is incident on the opposing substrate 20 side, is modulated by a liquid crystal layer 15, and is emitted from the element substrate 10 side.

The element substrate 10 is larger than the opposing substrate 20. Both substrates are adhered to each other via a sealing material 14 which is disposed along an outer circumference of the opposing substrate 20. A liquid crystal which has positive or negative dielectric anisotropy is sealed to a void between the element substrate 10 and the opposing substrate 20, and the liquid crystal layer 15 is formed. The sealing material 14 uses an epoxy resin or the like which has thermosetting properties or ultraviolet curing properties as an adhesive. In the sealing material 14, a spacer (not illustrated) for holding the interval between the element substrate 10 and the opposing substrate 20 constantly is mixed.

On the inner side of the sealing material 14, a display region E, in which a plurality of pixels P is aligned, is provided. In addition to the plurality of pixels P which contributes to displaying, the display region E may include dummy pixels which are disposed to surround the plurality of pixels P.

Between the sealing material 14 which is along one-side portion of the element substrate 10 and the one-side portion, a signal line driving circuit 22 is provided. In addition, between the sealing material 14 along the other one-side portion which opposes the one-side portion and the display region E, an inspection circuit 25 is provided. Furthermore, between the sealing material 14 along the other two-side portions which are perpendicular to the one-side portion and oppose each other and the display region E, the scanning line driving circuit 24 is provided. Between the sealing material 14 along the other one-side portion which opposes the one-side portion and the inspection circuit 25, a plurality of wirings 29 which links two scanning line driving circuits 24 to each other is provided.

On the opposing substrate 20, on the inner side of the frame-shaped sealing material 14, light shielding portions 18 (corner portion) having the same frame shape are provided. For example, the light shielding portion 18 is made of metal or metal oxide which has light shielding properties, and the inner side of the light shielding portion 18 is made of the display region E having the plurality of pixels P.

The wiring which links the signal line driving circuit 22 and the scanning line driving circuit 24 to each other is connected to a plurality of external connection terminals 61 which is aligned along the one-side portion.

Hereinafter, a direction along the one-side portion is considered as an X direction, and a direction along the other two-side portions which are perpendicular to the one-side portion and oppose each other is considered as a Y direction.

In addition, the X direction is the polarizing direction of the polarizing element 1a (refer to FIG. 1) which is disposed on the incidence side of the color light, and is an example of a “first direction” in the invention. The Y direction is the polarizing direction of the polarizing element 1b (refer to FIG. 1) which is disposed on the emitting side of the color light, and is an example of a “second direction” in the invention.

As illustrated in FIG. 3, on a front surface on the liquid crystal layer 15 side of the first base member 11, a pixel electrode 27 and a TFT 30 having light transmission properties which are provided in each pixel P, a signal wiring, and a first orientation film 28 which covers these members, are formed. In other words, the pixel electrode 27 and the TFT 30 are disposed in the display region E.

In addition, the TFT 30 is an example of the “pixel switching element” in the invention.

On a front surface on the liquid crystal layer 15 side of the second base member 21, the light shielding portion 18, a planarization layer 33 which is formed to cover the light shielding portion 18, a common electrode 31 which is provided to cover the planarization layer 33, and a second orientation film 32 which covers the common electrode 31, are provided.

As illustrated in FIG. 2, the light shielding portion 18 is provided at a position for surrounding the display region E, and being overlapped with the scanning line driving circuit 24 and the inspection circuit 25 in a plan view. Accordingly, a function of shielding the light which is incident on a peripheral circuit including the driving circuit from the opposing substrate 20 side, and preventing a malfunction of the peripheral circuit due to the light, is achieved. Furthermore, the light shielding portion 18 blocks unnecessary stray light not to be incident on the display region E, and realizes high contrast in the display of the display region E.

The planarization layer 33 is made of an inorganic material, such as silicon oxide, has light transmission properties, and is provided to cover the light shielding portion 18.

The common electrode 31 is made of a transparent conducting film, such as indium tin oxide (ITO), covers the planarization layer 33, and is electrically connected to the wiring on the element substrate 10 side by a vertical conduction portion 26 provided at four corners of the opposing substrate 20 as illustrated in FIG. 2.

The first orientation film 28 which covers the pixel electrode 27 and the second orientation film 32 which covers the common electrode 31 are selected based on an optical design of the liquid crystal device 1. Examples of the orientation films include an organic orientation film which is formed of an organic material, such as polyimide, and is substantially and horizontally orientation-processed with respect to a liquid crystal particle having positive dielectric anisotropy by rubbing the front surface, or an inorganic orientation film which is formed of an inorganic material, such as silicon oxide, by using a vapor growth method, and is substantially and vertically orientated with respect to the liquid crystal particle having negative dielectric anisotropy.

In addition, in the embodiment, the above-described inorganic orientation film is used as the first orientation film 28 and the second orientation film 32.

The liquid crystal device 1 is a transmission type, and uses an optical design of a normally white mode which displays brightness when the pixels P are not driving, or a normally black mode which displays darkness when the pixels P are not driving. In addition, in the embodiment, the normally black mode is used.

As illustrated in FIG. 4, the liquid crystal device 1 includes a plurality of scanning lines 3 and a plurality of signal lines 4 which are insulated from each other and intersect each other at least in the display region E, a first wiring 6 which is provided in an extending direction of the signal lines 4, and a second wiring 7 which is provided in an extending direction of scanning lines 3. A direction in which the scanning lines 3 and the second wiring 7 extend is the X direction, and a direction in which the signal lines 4 and the first wiring 6 extend is the Y direction.

In addition, the first wiring 6 is an example of a “first light shielding film” in the invention, and the second wiring 7 is an example of a “second light shielding film” in the invention.

In a region which is divided by the scanning line 3 and the signal line 4, the pixel electrode 27, the TFT 30, and a capacitor element 16, are provided, and these members constitute a pixel circuit of the pixels P.

The scanning line 3 is electrically connected to a gate of the TFT 30, and the signal line 4 is electrically connected to a signal line side source-drain region (source region) of the TFT 30. The pixel electrode 27 is electrically connected to the pixel electrode side source-drain region (drain region) of the TFT 30.

The signal line 4 is connected to the signal line driving circuit 22 (refer to FIG. 2), and supplies image signals D1, D2, . . . , and Dn which are supplied from the signal line driving circuit 22 to each pixel P. The scanning line 3 is connected to the scanning line driving circuit 24 (refer to FIG. 1), and supplies scanning signals SC1, SC2, . . . , and SCm which are supplied from the scanning line driving circuit 24 to each pixel P.

The image signals D1 to Dn which are supplied from the signal line driving circuit 22 to the signal line 4 may be line-sequentially supplied in this order, and may be supplied to each group with respect to the plurality of signal lines 4 which are adjacent to each other. The scanning line driving circuit 24 line-sequentially supplies the scanning signals SC1 to SCm at a predetermined timing like a pulse, with respect to the scanning line 3.

The liquid crystal device 1 has a configuration in which the image signals D1 to Dn which are supplied from the signal line 4 are written into the pixel electrode 27 at a timing when the TFT 30 which is a switching element is in an ON state for a certain period by inputting the scanning signals SC1 to SCm. The image signals D1 to Dn having a predetermined level which are written into the liquid crystal layer 15 via the pixel electrode 27 are held for a certain period between the pixel electrode 27 and the common electrode 31.

The capacitor element 16 is provided between the pixel electrode side source-drain region of the TFT 30 and the first wiring 6, and the same potential (LCCOM potential) as that of the common electrode 31 is supplied to the first wiring 6. In other words, the capacitor element 16 is connected in parallel to a liquid crystal capacitor which is formed between the pixel electrode 27 and the common electrode 31, and a leakage of the image signals D1 to Dn which is held between the pixel electrode 27 and the common electrode 31 is suppressed.

The first wiring 6 and the second wiring 7 are electrically connected to each other at a part where both wirings intersect each other, and the fixed potential (LCCOM potential) is supplied. In other words, the first wiring 6 and the second wiring 7 are wirings to which the fixed potential is supplied.

The LCCOM potential is supplied to the common electrode 31, the first wiring 6, and the second wiring 7. In other words, since the wiring to which the LCCOM potential is supplied is configured of the common electrode 31, the first wiring 6, and the second wiring 7, for example, compared to a case where the wiring is configured only of the common electrode 31, a time constant of the wiring to which the LCCOM potential is supplied becomes smaller, responsiveness of the wiring to which the LCCOM potential is supplied becomes more excellent, and writing-in properties are improved. As the wiring-in properties are improved, a crosstalk or the like is reduced, and display quality is improved.

### Overview of Element Substrate (Configuration in a Plan View)

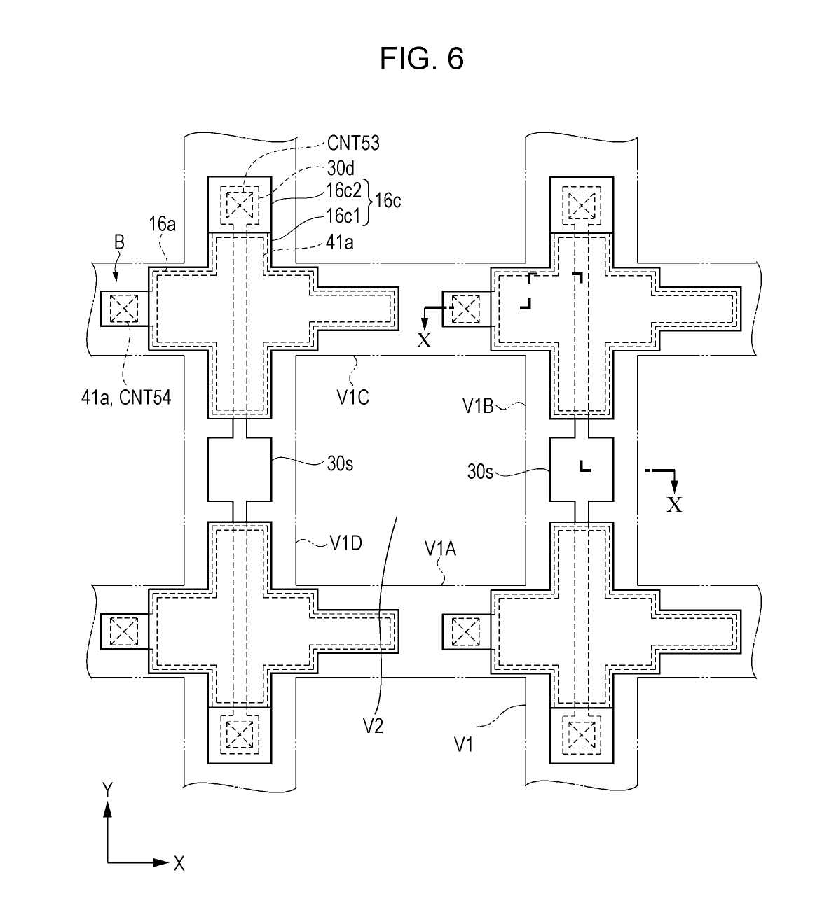

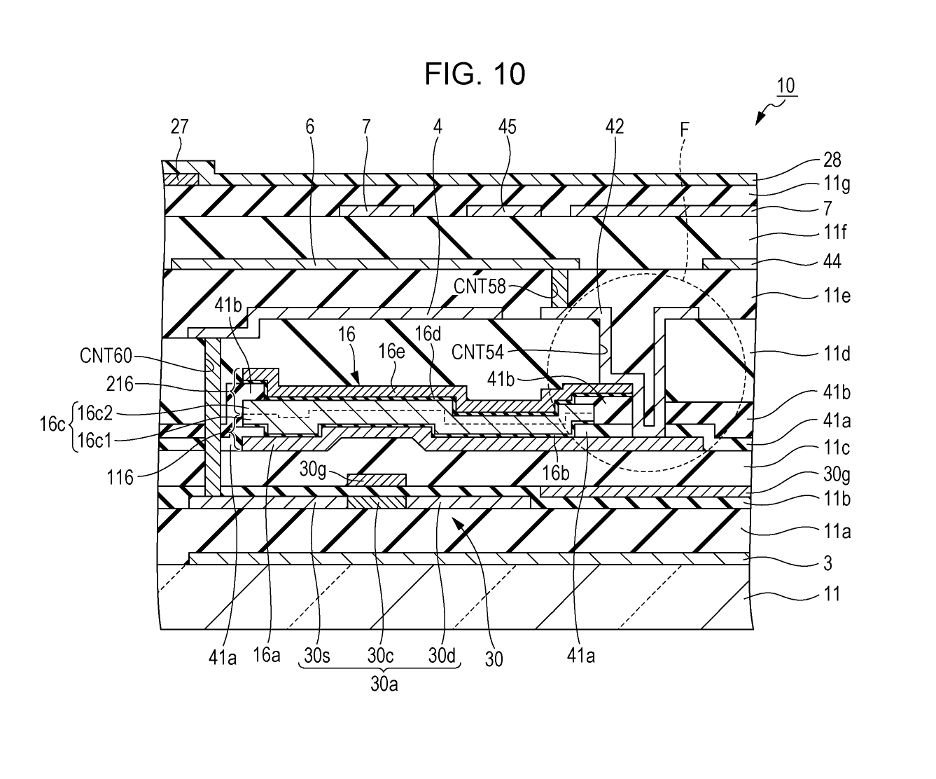

FIGS. 5 to 9 are schematic plan views illustrating a configuration of the element substrate. FIG. 10 is a schematic cross-sectional view of the element substrate along line X-X in FIGS. 5 to 9.

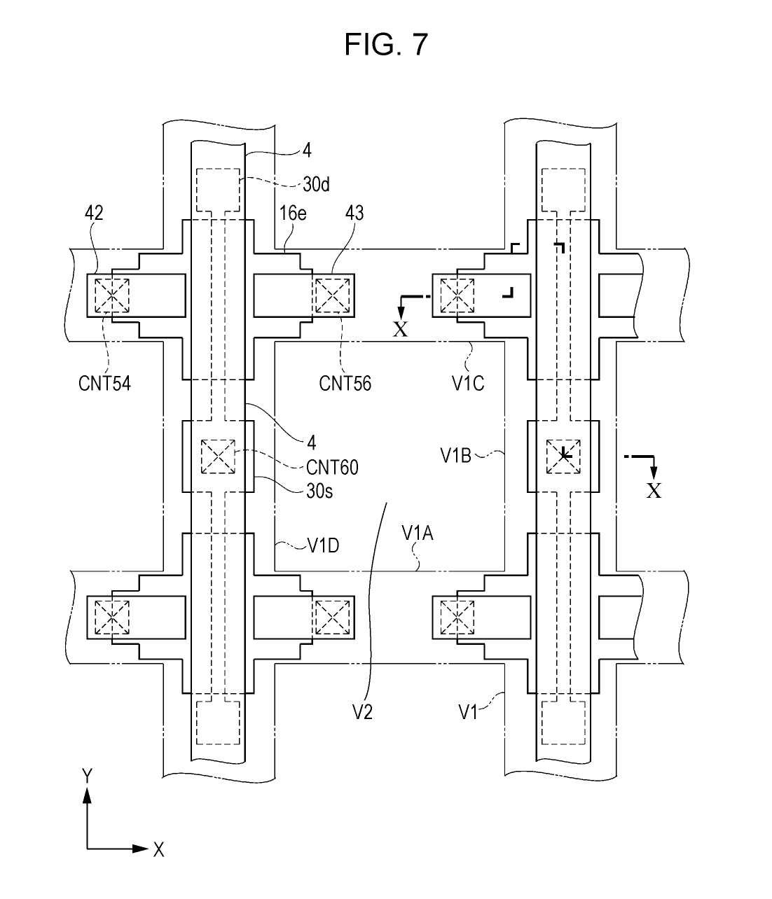

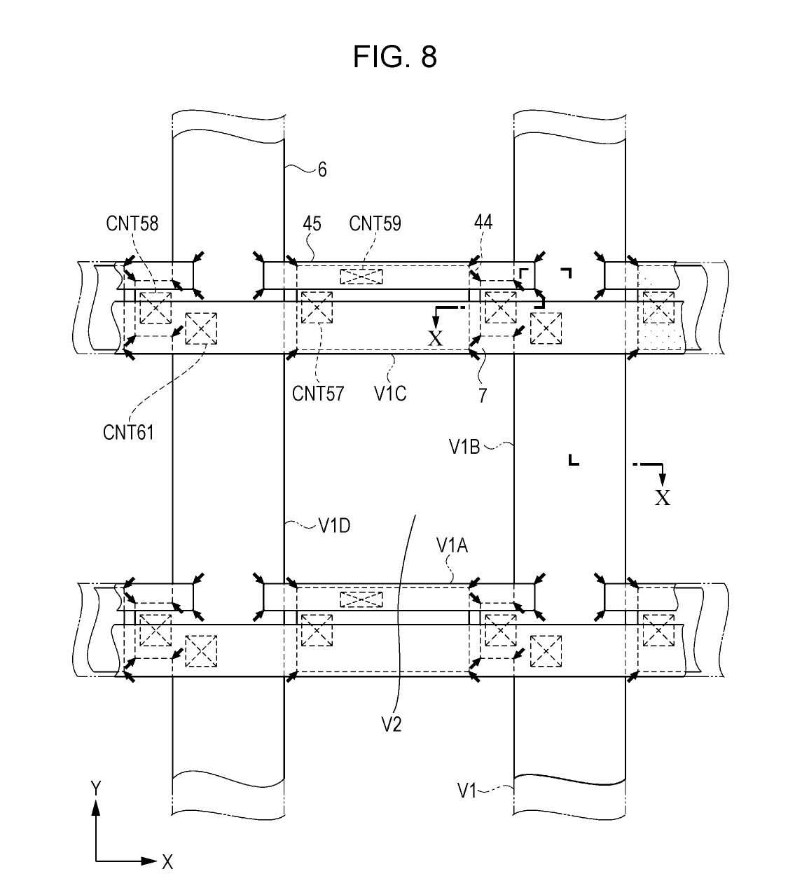

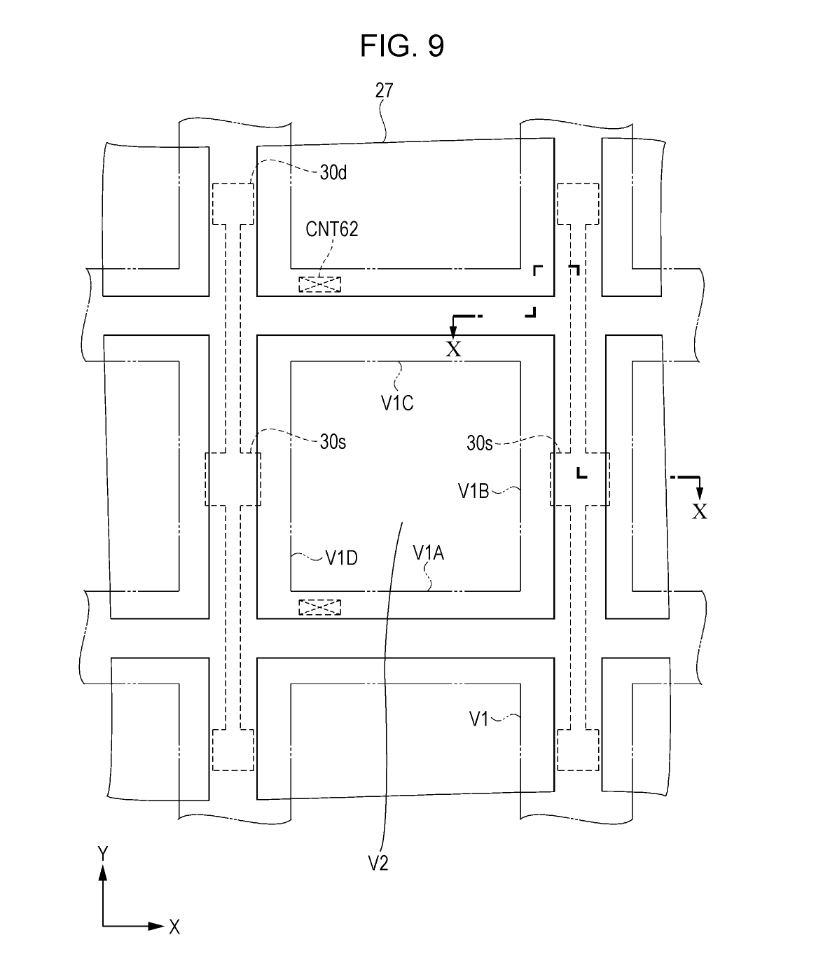

FIG. 5 illustrates a state from the scanning line 3 to a gate electrode 30g. FIG. 6 illustrates a state from a first capacitor electrode 16a to a second capacitor electrode 16c. FIG. 7 illustrates a state from a third capacitor electrode 16e to the signal line 4. FIG. 8 is a state from the first wiring 6 to the second wiring 7. FIG. 9 illustrates a state of the pixel electrode 27.

In FIGS. 5 to 9, in order to make it easy to understand a position of forming of constituent elements of the element substrate 10, a semiconductor layer 30a is illustrated.

Furthermore, FIGS. 5 to 9 illustrate a light shielding region V1 by a two-dot chain line. Although this will be describe in detail later, the light shielding region V1 is formed of the constituent elements (scanning line 3, signal line 4, first wiring 6, second wiring 7, and third capacitor electrode 16e) of the element substrate 10 which is configured of a conductive material having light shielding properties. In other words, a part where the constituent elements of the element substrate 10 which is configured of the conductive material having light shielding properties is overlapped in a plan view, is the light shielding region V1.

A region which is surrounded by the light shielding region V1 is a light transmitting region V2 which transmits the light. For this reason, the light transmitting region V2 is defined by an outer edge V1A, an outer edge V1B, an outer edge V1C, and an outer edge V1D of the light shielding region V1.

In addition, the light transmitting region V2 is an example of a “pixel opening portion” in the invention. Hereinafter, the outer edge V1A, the outer edge V1B, the outer edge V1C, and the outer edge V1D of the light shielding region V1 is referred to as a side V1A, a side V1B, a side V1C, and a side V1D.

Hereinafter, a configuration of the element substrate 10 in a plan view will be described with reference to FIGS. 5 to 9.

As illustrated in FIG. 5, the scanning line 3 is provided to extend in the X direction. The scanning line 3 has an overhung part in the Y direction. The scanning line 3 is configured of the conductive material having light shielding properties, such as a metal simple substance including at least one of metals having a high melting point, for example, titanium, chrome, tungsten, tantalum, or molybdenum, a metal silicide, a polysilicide, a nitride, or a material in which these materials are layered, and makes up a part of the light shielding region V1.

Along the overhung part of the scanning line 3 in the Y direction, the semiconductor layer 30a is provided. The semiconductor layer 30a includes a signal line side source-drain region 30s (high concentration impurities region), a pixel electrode side source-drain region 30d (high concentration impurities region), and a channel region 30c. Although not illustrated in the drawing, the low concentration impurities region (LDD region) is formed between the signal line side source-drain region 30s and the channel region 30c and between the pixel electrode side source-drain region 30d and the channel region 30c.

The gate electrode 30g which extends in the X direction is provided to nip the semiconductor layer 30a and oppose the scanning line 3. The gate electrode 30g is configured of, for example, a polycrystal silicon, and is provided to be overlapped with the scanning line 3 in a plan view. The semiconductor layer 30a of the part which is overlapped with the gate electrode 30g in a plan view is the channel region 30c.

The gate electrode 30g is electrically connected to the scanning line 3 via contact holes CNT51 and CNT52. As the gate electrode 30g functions as a second scanning line, and as a redundant configuration is employed by the scanning line 3 and the gate electrode 30g, disconnection of wiring is prevented.

As the scanning line 3 is formed to be wider than the semiconductor layer 30a, light in a direction toward the opposing substrate 20 from the element substrate 10, for example, reflected light of the light toward the element substrate 10 from the opposing substrate 20 is unlikely to be incident on the channel region 30c of the semiconductor layer 30a, and an optical malfunction of the TFT 30 is suppressed.

All of the scanning line 3, the semiconductor layer 30a, and the gate electrode 30g which are described above are disposed on an inner side of the light shielding region V1, and all of a corner portion of the scanning line 3, a corner portion of the semiconductor layer 30a, and a corner portion of the gate electrode 30g are hidden (covered) by the light shielding region V1.

As illustrated in FIG. 6, at the part where the TFT 30 is formed, the island-shaped first capacitor electrode 16a, a first dielectric layer 16b (refer to FIG. 10), and the island-shaped second capacitor electrode 16c (first conductive layer 16c1, and second conductive layer 16c2) are layered in order.

The first capacitor electrode 16a and the second capacitor electrode 16c are configured of, for example, a polycrystal silicon film.

An outer edge of the first capacitor electrode 16a is covered with a first insulating film CAPA41a which is made of an etching stopper when the second capacitor electrode 16c is formed (refer to FIG. 10). In FIG. 6, an outer edge (outline) of the first insulating film CAPA41a is illustrated by a dashed line, and a region which is surrounded by the dashed line is an opening region in which the first insulating film CAPA41a is not formed.

At a part which is illustrated by an arrow which is given a reference numeral B, the first capacitor electrode 16a is overhung from the second capacitor electrode 16c. In the first capacitor electrode 16a of the overhung part, the opening region of the first insulating film CAPA41a which is surrounded by the dashed line having a square shape is formed. The opening region of the first insulating film CAPA41a is a contact hole CNT54 (refer to FIG. 7) which will be described later.

The second capacitor electrode 16c includes a two-layered structure which is made of the first conductive layer 16c1 and the second conductive layer 16c2 which are layered in order from the first base member 11 side (refer to FIG. 10). The second conductive layer 16c2 in the second capacitor electrode 16c is overhung from the first conductive layer 16c1, and is provided up to a region which is overlapped with the pixel electrode side source-drain region 30d of the semiconductor layer 30a in a plan view. In the region, the second conductive layer 16c2 is electrically connected to the pixel electrode side source-drain region 30d of the semiconductor layer 30a via a contact hole CNT53.

All of the first capacitor electrode 16a and the second capacitor electrode 16c (first conductive layer 16c1 and second conductive layer 16c2) are disposed on the inner side of the light shielding region V1, and all of a corner portion of the first capacitor electrode 16a and a corner portion of the second capacitor electrode 16c are hidden (covered) by the light shielding region V1.

As illustrated in FIG. 7, on the second capacitor electrode 16c (refer to FIG. 6), a second dielectric layer 16d (refer to FIG. 10) and the third capacitor electrode 16e are layered in order. The third capacitor electrode 16e is configured of, for example, the conductive material having light shielding properties, such as tungsten silicide, is provided in an island shape to be overlapped with the first capacitor electrode 16a in a substantial plan view, and makes up a part of the light shielding region V1.

Furthermore, on the third capacitor electrode 16e, the signal line 4 which extends in the Y direction is provided. The signal line 4 is configured of aluminum or the conductive material having light shielding properties including aluminum, and makes up a part of the light shielding region V1. The signal line 4 is provided to cover the semiconductor layer 30a, and is electrically connected to the signal line side source-drain region 30s of the semiconductor layer 30a via a contact hole CNT60.

Along the part which extends in the X direction of the light shielding region V1, a first relay electrode 42 and a second relay electrode 43 are respectively provided in an island shape. The first relay electrode 42 and the second relay electrode 43 are disposed nipping the signal line 4, and are formed of the same material as that of the signal line 4. In other words, the first relay electrode 42 and the second relay electrode 43 also make up a part of the light shielding region V1.

Furthermore, the contact hole CNT54 which is partially overlapped with the first relay electrode 42 is provided, and a contact hole CNT56 which is overlapped with the second relay electrode 43 is provided. The second relay electrode 43 is electrically connected to the second conductive layer 16c2 (second capacitor electrode 16c) via the contact hole CNT56.

The third capacitor electrode 16e, the signal line 4, the first relay electrode 42, and the second relay electrode 43 which are described above, are disposed on the inner side of the light shielding region V1, and all of a corner portion of the third capacitor electrode 16e, a corner portion of the first relay electrode 42, and a corner portion of the second relay electrode 43 are hidden (covered) by the light shielding region V1.

As illustrated in FIG. 8, the first wiring 6 is provided to cover the signal line 4 in the Y direction. The first wiring 6 includes an overhung part in the X direction, and is provided with a contact hole CNT58 at the overhung part in the X direction. The first wiring 6 is electrically connected to the first relay electrode 42 via the contact hole CNT58.

Between the first wiring 6 and the adjacent first wiring 6, an island-shaped third relay electrode 44 which is long in the X direction is provided. The third relay electrode 44 is electrically connected to the second relay electrode 43 via a contact hole CNT57.

The first wiring 6 and the third relay electrode 44 are provided on the same layer, is configured of aluminum or the conductive material having light shielding properties including aluminum, and makes up a part of the light shielding region V1. In other words, the first wiring 6 and the third relay electrode 44 are formed of the same material as each other in the same process.

In addition, the third relay electrode 44 is an example of a “first conducting film having light shielding properties” in the invention.

The second wiring 7 is provided along the X direction, and is provided with a contact hole CNT61 at a part where the second wiring 7 and the first wiring 6 are overlapped with each other. The second wiring 7 is electrically connected to the first wiring 6 via the contact hole CNT61.

An island-shaped fourth relay electrode 45 which is long in the X direction is provided to oppose the second wiring 7. A contact hole CNT59 is provided at a part where the fourth relay electrode 45 and the third relay electrode 44 are overlapped with each other. The fourth relay electrode 45 is electrically connected to the third relay electrode 44 via the contact hole CNT59.

The second wiring 7 and the fourth relay electrode 45 are provided on the same layer, are configured of aluminum or the conductive material having light shielding properties including aluminum, and make up a part of the light shielding region V1. In other words, the second wiring 7 and the fourth relay electrode 45 are formed of the same material as each other in the same process.

In addition, the fourth relay electrode 45 is an example of a “second conducting film having light shielding properties” in the invention.

In addition, in the light shielding region V1, since a part which is not covered with the first wiring 6, the second wiring 7, the third relay electrode 44, and the fourth relay electrode 45, is covered (hidden) with other light shielding films (scanning line 3, signal line 4, and third capacitor electrode 16e), light leakage does not occur.

Furthermore, the first wiring 6, the second wiring 7, and the fourth relay electrode 45 forms an outer edge of the light shielding region V1. Specifically, an outer edge which is long in the X direction of the fourth relay electrode 45 is the side VIA which defines the light transmitting region V2. An outer edge along the Y direction of the first wiring 6 is the side V1B and the side V1D which define the light transmitting region V2. An outer edge along the X direction of the second wiring 7 is the side V1C which defines the light transmitting region V2.

Any of the sides V1A, V1B, V1C, and V1D of the light shielding region V1, which are formed of the first wiring 6, the second wiring 7, and the fourth relay electrode 45, make a straight line, and are disposed along the X direction or the Y direction, that is, are disposed along the polarizing direction of the polarizing element 1a (refer to FIG. 1) or the polarizing direction of the polarizing element 1b (refer to FIG. 1).

The light transmitting region V2 is defined by the outer edge (side V1B, side V1D) along the Y direction of the first wiring 6, the outer edge (V1C) along the X direction of the second wiring 7, and the outer edge (side V1A) which is long in the X direction of the fourth relay electrode 45. In other words, the light transmitting region V2 is defined by the sides V1A and V1C along the polarizing direction of the polarizing element 1a which is disposed on the incidence side of the color light, and by the sides V1B and V1D along the polarizing direction of the polarizing element 1b which is disposed on the emitting side of the color light. Therefore, the sides V1A, V1B, V1C, and V1D of the light shielding region V1 which define the light transmitting region V2 do not include a part which intersects both the polarizing direction of the polarizing element 1a and the polarizing direction of the polarizing element 1b.

If the sides of the light shielding region V1 which define the light transmitting region V2 include the part which intersects the polarizing direction of the polarizing element 1a and the polarizing direction of the polarizing element 1b, by the part which intersects the polarizing directions, a part of the light which transmits the light transmitting region V2 is polarized in a direction which is different from a direction in which the light is originally to be polarized, the polarization state changes, and a defect of deterioration of display contrast due to the leakage light is generated.

In the embodiment, since the sides of the light shielding region V1 which define the light transmitting region V2 do not include the part which intersects the polarizing direction of the polarizing element 1a and the polarizing direction of the polarizing element 1b, the polarization state of the light which transmits the light transmitting region V2 does not change, and a defect of deterioration of display contrast is suppressed.

In addition, a corner portion of the first wiring 6 which is illustrated by an arrow is covered (hidden) with the second wiring 7 and the fourth relay electrode 45. Furthermore, a corner portion of the third relay electrode 44 which is illustrated by an arrow is covered (hidden) with the second wiring 7 and the fourth relay electrode 45. Furthermore, a corner portion of the fourth relay electrode 45 which is illustrated by an arrow is covered (hidden) with the first wiring 6.

The corner portion of the first wiring 6, the corner portion of the third relay electrode 44, and the corner portion of the fourth relay electrode 45 are formed by patterning by using a photolithography process method and a dry etching method which are known technologies, after forming a film by aluminum or the material including aluminum by a sputtering method which is a known technology. In the photolithography process method which is the known technology, it is difficult to form the corner portion in a rectangular shape and a round shape (roundness) is formed in the corner portion. Accordingly, the corner portion illustrated by the arrow has a round shape (roundness) without a rectangular shape. Therefore, the corner portion of the first wiring 6 illustrated by the arrow, the corner portion of the third relay electrode 44 illustrated by the arrow, and the corner portion of the fourth relay electrode 45 illustrated by the arrow, include the part which intersects the polarizing direction of the polarizing element 1a and the polarizing direction of the polarizing element 1b.

If the corner portion of the first wiring 6, the corner portion of the third relay electrode 44, and the corner portion of the fourth relay electrode 45 are not hidden by the light shielding film, the part which intersects the polarizing direction of the polarizing element 1a and the polarizing direction of the polarizing element 1b is exposed, and by the part which intersects the polarizing directions, a part of the light which transmits the light transmitting region V2 is polarized in the direction which is different from the direction in which the light is originally to be polarized, the polarization state changes, and a defect of deterioration of display contrast due to the leakage light is generated.

In the embodiment, since all of the corner portion of the first wiring 6, the corner portion of the third relay electrode 44, and the corner portion of the fourth relay electrode 45 are hidden by the light shielding region V1, the polarization state of the light which transmits the light transmitting region V2 does not change, and deterioration of display contrast is suppressed.

As described above, all of the corner portion of the scanning line 3, the corner portion of the semiconductor layer 30a, and the corner portion of the gate electrode 30g are hidden by the light shielding region V1 (refer to FIG. 5). All of the corner portion of the first capacitor electrode 16a and the corner portion of the second capacitor electrode 16c are hidden by the light shielding region V1 (refer to FIG. 6). All of the corner portion of the third capacitor electrode 16e, the corner portion of the first relay electrode 42, and the corner portion of the second relay electrode 43 are hidden by the light shielding region V1 (refer to FIG. 7). Therefore, when these corner portions are exposed, the polarization state of the light which transmits the light transmitting region V2 changes, and it is possible to suppress a defect of deterioration of display contrast.

As illustrated in FIG. 9, the pixel electrode 27 is provided in an island shape to cover the light transmitting region V2. In other words, a circumferential edge portion of the pixel electrode 27 is provided to be overlapped with the light shielding region V1 in a plan view. A contact hole CNT62 is provided at a part where the pixel electrode 27 and the light shielding region V1 (fourth relay electrode 45) are overlapped with each other. The pixel electrode 27 is connected to the fourth relay electrode 45 via the contact hole CNT62.

In other words, the pixel electrode 27 is electrically connected to the pixel electrode side source-drain region 30d of the semiconductor layer 30a via the contact hole CNT62, the fourth relay electrode 45, the contact hole CNT59, the third relay electrode 44, the contact hole CNT57, the second relay electrode 43, the contact hole CNT56, the second conductive layer 16c2 (second capacitor electrode 16c), and a contact hole CNT53.

### Overview (Cross-Sectional Structure) of Element Substrate

Next, a cross-sectional structure of the element substrate 10 will be described with reference to FIG. 10.

As illustrated in FIG. 10, the scanning line 3 is provided on the first base member 11. For example, an underlying insulating film 11a which is made of silicon oxide or the like is provided to cover the first base member 11 and the scanning line 3. The island-shaped semiconductor layer 30a is provided on the underlying insulating film 11a.

The semiconductor layer 30a is made of, for example, a polycrystal silicon, and is formed of an LDD region (not illustrated) into which impurity ion is injected, the signal line side source-drain region 30s, the channel region 30c, the pixel electrode side source-drain region 30d, or the like.

A first interlayer insulating layer (gate insulating layer) 11b is formed to cover the semiconductor layer 30a and the underlying insulating film 11a. The first interlayer insulating layer 11b is configured of silicon oxide or the like. Furthermore, the gate electrode 30g is provided at a position where the gate electrode 30g nips the first interlayer insulating layer 11b and opposes the channel region 30c of the semiconductor layer 30a.

A second interlayer insulating layer 11c is provided to cover the gate electrode 30g and the first interlayer insulating layer 11b. The second interlayer insulating layer 11c is configured of the silicon oxide or the like. On the second interlayer insulating layer 11c, the first capacitor electrode 16a, the first dielectric layer 16b, and the first conductive layer 16c1 (second capacitor electrode 16c) are layered in order, and a first capacitor element 116 is formed.

Although this will be described later, the first capacitor electrode 16a is electrically connected to the first wiring 6, and the LCCOM potential (fixed potential) is supplied.

The first dielectric layer 16b is configured of a single layer film which is made of silicon nitride or silicon oxide, and a multi-layer film which includes the single layer films. On the first dielectric layer 16b, the island-shaped first conductive layer 16c1 (second capacitor electrode 16c) is provided.

As described above, the second capacitor electrode 16c is configured of a two-layered polycrystal silicon film, and includes the first conductive layer 16c1 which is formed by patterning on the TFT 30 side, and the second conductive layer 16c2 which is formed by patterning on the pixel electrode 27 side. The second capacitor electrode 16c is electrically connected to the pixel electrode side source-drain region 30d of the semiconductor layer 30a via the contact hole CNT53 (refer to FIG. 6). Furthermore, the second capacitor electrode 16c is electrically connected to the pixel electrode 27 via the contact hole CNT56 (refer to FIG. 7), the second relay electrode 43, the contact hole CNT57 (refer to FIG. 8), the third relay electrode 44, and the contact hole CNT59 (refer to FIG. 8), the fourth relay electrode 45, and the contact hole CNT62 (refer to FIG. 9). In other words, the second capacitor electrode 16c is a pixel potential side capacitor electrode which is electrically connected to the pixel electrode side source-drain region 30d of the semiconductor layer 30a and the pixel electrode 27.

The first insulating film CAPA41a is formed to cover a circumferential edge portion of the first capacitor electrode 16a, and a second insulating film CAPA41b is formed to cover a circumferential edge portion of the second capacitor electrode 16c. In other words, the first insulating film CAPA41a is formed between the first capacitor electrode 16a and the first dielectric layer 16b to cover the circumferential edge portion of the first capacitor electrode 16a. The second insulating film CAPA41b is formed between the second conductive layer 16c2 and the second dielectric layer 16d to cover the circumferential edge portion of the second conductive layer 16c2.

The first insulating film CAPA41a prevents each electrical short between an end surface of the first capacitor electrode 16a and an end surface of the second capacitor electrode 16c, and is an etching stopper when forming the second capacitor electrode 16c by dry etching or the like. The second insulating film CAPA41b prevents each electrical short between the end surface of the second capacitor electrode 16c and an end surface of the third capacitor electrode 16e, and is an etching stopper when forming the third capacitor electrode 16e by dry etching or the like. In addition, an opening portion of the first insulating film CAPA41a provided on the first capacitor electrode 16a and an opening portion of the second insulating film CAPA41b provided on the second capacitor electrode 16c, are overlapped with each other in a plan view, and have substantially the same shape.

On the second capacitor electrode 16c, the second dielectric layer 16d and the third capacitor electrode 16e are layered in order, and the second accommodation portion 216 is formed. Similarly to the first dielectric layer 16b, the second dielectric layer 16d is configured of a single layer film which is made of silicon oxide or silicon nitride, and a multi-layer film which includes the single layer films.

In a region F which is surrounded by a dashed line, the outer edge (end surface) of the first capacitor electrode 16a is overhung from the outer edge (end surface) of the second capacitor electrode 16c, and the outer edge (end surface) of the third capacitor electrode 16e is disposed between the outer edge (end surface) of the first capacitor electrode 16a and the outer edge (end surface) of the second capacitor electrode 16c. Furthermore, the contact hole CNT54 which penetrates the first insulating film CAPA41a, the second insulating film CAPA41b, and the third interlayer insulating layer 11d, to expose a part of the first capacitor electrode 16a and a part of the third capacitor electrode 16e. In other words, the contact hole CNT54 which exposes the first capacitor electrode 16a and the third capacitor electrode 16e is provided in the region F.

In addition, since the second insulating film CAPA41b is disposed between the contact hole CNT54 and the second capacitor electrode 16c, the second capacitor electrode 16c is electrically separated from the first capacitor electrode 16a and the third capacitor electrode 16e.

Furthermore, the contact hole CNT54 is covered with the first relay electrode 42. As a result, the first capacitor electrode 16a and the third capacitor electrode 16e are in contact with the first relay electrode 42 inside the contact hole CNT54, and are electrically connected to each other by the first relay electrode 42.

As described above, since the first relay electrode 42 is electrically connected to the first wiring 6 via the contact hole CNT58 (refer to FIG. 8), the first capacitor electrode 16a and the third capacitor electrode 16e are electrically connected to the first wiring 6 via the contact hole CNT54, the first relay electrode 42, and the contact hole CNT58 (refer to FIG. 8), and the same potential as that of the first wiring 6, that is, the LCCOM potential (fixed potential) is supplied.

In other words, the first capacitor electrode 16a is a fixed potential side capacitor electrode in the first capacitor element 116, and the third capacitor electrode 16e is a fixed potential side capacitor electrode in the second accommodation portion 216.

In this manner, in the embodiment, by one contact hole (contact hole CNT54), the first capacitor electrode 16a and the third capacitor electrode 16e which are disposed on different layers are electrically connected to each other. As a result, the capacitor element 16 is configured of the first capacitor element 116 and the second accommodation portion 216 which are connected to each other in parallel, and can increase a capacity value per unit area in the pixel P. By increasing the capacity value of the capacitor element 16, it is possible to improve potential holding properties of the pixel electrode 27, and to improve display performance by improving contrast and reducing flickers.

A third interlayer insulating layer 11d is layered on the third capacitor electrode 16e. The third interlayer insulating layer 11d is configured of a film which includes any of silicon oxide, silicon nitride, or silicon oxynitride.

Furthermore, on the third interlayer insulating layer 11d, the signal line 4, the first relay electrode 42 (refer to FIG. 7), and the second relay electrode 43 are provided. The signal line 4 is electrically connected to the signal line side source-drain region 30s of the semiconductor layer 30a, via the contact hole CNT60 which penetrates the third interlayer insulating layer 11d, the second insulating film CAPA41b, the first insulating film CAPA41a, the second interlayer insulating layer 11c, and the first interlayer insulating layer 11b.

A fourth interlayer insulating layer 11e is provided to cover the signal line 4, the first relay electrode 42, and the second relay electrode 43 (refer to FIG. 7). The fourth interlayer insulating layer 11e is configured of a film which includes any of silicon oxide, silicon nitride, or silicon oxynitride.

On the fourth interlayer insulating layer 11e, the first wiring 6 or the third relay electrode 44 are provided. The first wiring 6 is overlapped with the signal line 4 in a plan view, and is formed to be wider than the signal line 4.

A fifth interlayer insulating layer 11f is provided to cover the first wiring 6 or the third relay electrode 44. The fifth interlayer insulating layer 11f is configured of a film which includes any of silicon oxide, silicon nitride, or silicon oxynitride.

On the fifth interlayer insulating layer 11f, the second wiring 7 and the fourth relay electrode 45 are provided.

A sixth interlayer insulating layer 11g is provided to cover the second wiring 7 and the fourth relay electrode 45. The sixth interlayer insulating layer 11g is configured of a film which includes any of silicon oxide, silicon nitride, or silicon oxynitride.

On the sixth interlayer insulating layer 11g, the pixel electrode 27 which is made of the ITO film or the like is provided by patterning. Furthermore, the pixel electrode 27 is covered with the first orientation film 28.

In this manner, the signal line 4 which extends in the Y direction is provided between the TFT 30 and the pixel electrode 27, the first wiring 6 is disposed on a layer on a side close to the signal line 4 between the signal line 4 and the pixel electrode 27, and the second wiring 7 is disposed on a layer on a side close to the pixel electrode 27 between the signal line 4 and the pixel electrode 27.

In other words, since the first wiring 6 and the second wiring 7 to which the LCCOM potential (fixed potential) is supplied are provided between the pixel electrode 27 and the signal line 4, influence of the electric field of the signal line 4, that is, coupling between the signal line 4 and the pixel electrode 27 is reduced, and it is possible to improve display quality.

Furthermore, the first wiring 6 and the second wiring 7 are disposed nipping the fifth interlayer insulating layer 11f. Compared to the known technology (JP-A-2010-160308) in which the two light shielding films which form the light shielding region are disposed to be apart from each other nipping the TFT, since the two light shielding films (first light shielding film and second light shielding film) which form the light shielding region V1 are disposed to be close to each other, light shielding properties of the light shielding region V1 is improved, and a concern about generating of light leakage is reduced.

As described above, in the embodiment, it is possible to achieve the following effects.

(1) The wiring to which the LCCOM potential is supplied is configured of the common electrode 31, the first wiring 6, and the second wiring 7, and further, the first wiring 6 and the second wiring 7 are configured of aluminum or a low resistance material (light shielding material) which includes aluminum. For this reason, the time constant of the wiring to which the LCCOM potential is supplied becomes smaller, responsiveness of the wiring becomes more excellent, writing-in properties are improved. As the wiring-in properties are improved, a crosstalk or the like is reduced, and display quality is improved.

(2) The sides V1A, V1B, V1C, and V1D of the light shielding region V1 which define the light transmitting region V2 are disposed along the polarizing direction of the polarizing element 1a and the polarizing direction of the polarizing element 1b, and do not include the part which intersects both the polarizing direction of the polarizing element 1a and the polarizing direction of the polarizing element 1b. For this reason, the polarization state of the light which transmits the light transmitting region V2 does not change, and a defect of deterioration of display contrast is suppressed.

(3) All of the corner portion of the first wiring 6, the corner portion of the third relay electrode 44, the corner portion of the fourth relay electrode 45, the corner portion of the scanning line 3, the corner portion of the semiconductor layer 30a, the corner portion of the gate electrode 30g, the corner portion of the first capacitor electrode 16a, the corner portion of the second capacitor electrode 16c, the corner portion of the third capacitor electrode 16e, the corner portion of the first relay electrode 42, and the corner portion of the second relay electrode 43 are hidden by the light shielding region V1. Therefore, when these corner portions are exposed, the polarization state of the light which transmits the light transmitting region V2 changes, and it is possible to suppress a defect of deterioration of display contrast.

(4) Between the pixel electrode 27 and the signal line 4, the first wiring 6 and the second wiring 7 to which the LCCOM potential (fixed potential) is supplied is provided. For this reason, influence of the electric field of the signal line 4, that is, coupling between the signal line 4 and the pixel electrode 27 is reduced, and it is possible to improve display quality.

(5) Compared to the known technology (JP-A-2010-160308) in which the two light shielding films which form the light shielding region are disposed to be apart from each other nipping the TFT, the two light shielding films (first light shielding film and second light shielding film) which form the light shielding region V1 are disposed to be close to each other. For this reason, light shielding properties of the light shielding region V1 is improved, and a concern about light leakage is reduced.

The invention is not limited to the above-described embodiment, and can be appropriately changed without departing from an idea or a concept of the invention that can be read from the range of claims and the entire specification. A liquid crystal device in accordance with such a change, and an optical unit or an electronic apparatus which has the liquid crystal device mounted thereon, can also be included in the technical range of the invention.

Various modifications other than the above-described embodiment can be considered. Hereinafter, modification examples will be described.

### Modification Example 1

At least one side among the sides V1A, V1B, V1C, and V1D of the light shielding region V1 which define the light transmitting region V2 may partially include a concave portion or a convex portion. The sides V1A, V1B, V1C, and V1D of the light shielding region V1 which define the light transmitting region V2 is included in the technical range in which the invention is employed when these sides can be considered as substantially straight lines.

### Modification Example 2

The outer edges of the constituent elements (scanning line 3, third capacitor electrode 16e, signal line 4, first relay electrode 42, second relay electrode 43, third relay electrode 44, and fourth relay electrode 45) which are configured of the conductive material having light shielding properties may include a part which matches the sides V1A, V1B, V1C, and V1D of the light shielding region V1.

For example, when the outer edge of the third relay electrode 44 and the outer edge of the fourth relay electrode 45 match each other, both the outer edge of the third relay electrode 44 and the outer edge of the fourth relay electrode 45 are the side VIA which defines the light transmitting region V2. When the outer edge of the third relay electrode 44 and the outer edge of the second wiring 7 match each other, both the outer edge of the third relay electrode 44 and the outer edge of the second wiring 7 are the side V1C which defines the light transmitting region V2. In other words, the light transmitting region V2 is defined by the first wiring 6, the second wiring 7, the third relay electrode 44, and the fourth relay electrode 45.

### Modification Example 3

Any of the corner portion of the first wiring 6, the corner portion of the third relay electrode 44, the corner portion of the fourth relay electrode 45, the corner portion of the scanning line 3, the corner portion of the semiconductor layer 30a, the corner portion of the gate electrode 30g, the corner portion of the first capacitor electrode 16a, the corner portion of the second capacitor electrode 16c, the corner portion of the third capacitor electrode 16e, the corner portion of the first relay electrode 42, and the corner portion of the second relay electrode 43 may be configured to be partially overhung from the light shielding region V1. When it is possible to consider that these corner portions are substantially hidden by the light shielding region V1, these corner portions are included in the technical range in which the invention is employed.

Furthermore, the constituent elements (gate electrode 30g, semiconductor layer 30a, first capacitor electrode 16a, and second capacitor electrode 16c), which are configured of polycrystal silicon, makes the light partially transmit and have less negative influence (deterioration of display contrast) when these constituent elements are disposed in the direction which intersects the polarizing directions of the polarizing elements 1a and 1b, compared to the constituent elements (scanning line 3, third capacitor electrode 16e, signal line 4, first relay electrode 42, second relay electrode 43, first wiring 6, second wiring 7, third relay electrode 44, and fourth relay electrode 45) which are configured of the conductive material having light shielding properties. Therefore, the constituent elements, such as the polycrystal silicon, which the light partially transmits, may have a part which is overhung from the light shielding region V1.

For example, the corner portions of the constituent elements (gate electrode 30g, semiconductor layer 30a, first capacitor electrode 16a, and second capacitor electrode 16c), such as the polycrystal silicon, which the light partially transmits, may be included in the technical range in which the invention is employed even when the corner portions are not substantially hidden by the light shielding region V1, if the constituent elements (scanning line 3, third capacitor electrode 16e, signal line 4, first relay electrode 42, second relay electrode 43, first wiring 6, second wiring 7, third relay electrode 44, and fourth relay electrode 45) which are configured of the conductive material having light shielding properties can be considered to be substantially hidden by the light shielding region V1.

### Modification Example 4

The electronic apparatus in which the liquid crystal device 1 is employed is not limited to the projection type display apparatus 1000. For example, other than the projection type display apparatus 1000, it is possible to employ the liquid crystal device 1 in electronic apparatus, such as a projection type head-up display (HUD), a direct viewing type head-mounted display (HMD), an electronic book, a personal computer, a digital still camera, a liquid crystal television, a view finder type or a monitor direct viewing type video recorder, a car navigation system, an information terminal apparatus including a POS, and an electronic organizer.

### Modification Example 5

The optical unit according to the invention may be configured to have the liquid crystal device as an optical modulating unit, and the light synthesizing optical system (cross dichroic prism) which synthesizes and emits the light which is emitted from the liquid crystal device, and for example, may have a configuration in which the dichroic mirrors 1104 and 1105, the reflecting mirrors 1106, 1107, and 1108, the relay lenses 1201, 1202, 1203, 1204, and 1205 in above-described embodiment, are omitted.

Furthermore, the optical unit according to the invention can be employed in the electronic apparatus, such as the projection type of head-up display (HUD) other than the projection type display apparatus.

The entire disclosure of Japanese Patent Application No. 2014-082546, filed Apr. 14, 2014 is expressly incorporated by reference herein.

What is claimed is:

1. An electro-optical device which is disposed between a first polarizing element which polarizes light in a first direction, and a second polarizing element which polarizes the light in a second direction which intersects the first direction, comprising:
a substrate;
a pixel electrode;
a pixel switching element which is disposed between the substrate and the pixel electrode;
a first light shielding film which is disposed between the pixel switching element and the pixel electrode, and extends in one direction among the first direction and the second direction; and
a second light shielding film which is disposed between the pixel switching element and the pixel electrode, and extends in the other direction among the first direction and the second direction,
wherein a pixel opening portion is defined by an outer edge of the first light shielding film and an outer edge of the second light shielding film.

2. An electro-optical device which is disposed between a first polarizing element which polarizes light in a first direction, and a second polarizing element which polarizes the light in a second direction which intersects the first direction, comprising:
a substrate;
a pixel electrode;
a pixel switching element which is disposed between the substrate and the pixel electrode;
a first light shielding film which is disposed between the pixel switching element and the pixel electrode, and extends in one direction among the first direction and the second direction;
a second light shielding film which is disposed between the pixel switching element and the pixel electrode, and extends in the other direction among the first direction and the second direction;
a first conducting film having light shielding properties which is provided on the same layer as the first light shielding film; and
a second conducting film having light shielding properties which is provided on the same layer as the second light shielding film,
wherein a pixel opening portion is defined by an outer edge of the first light shielding film, an outer edge of the second light shielding film, and at least one outer edge of the first conducting film and the second conducting film.

3. The electro-optical device according to claim 1,
wherein a material which constitutes the first light shielding film and the second light shielding film is aluminum or a conductive material including aluminum.

4. The electro-optical device according to claim 1,
wherein a signal line is provided which extends in one direction among the first direction and the second direction between the pixel switching element and the pixel electrode,
wherein the first light shielding film is disposed on a layer between a layer on which the signal line is formed and a layer on which the pixel electrode is formed, and
wherein the second light shielding film is disposed on a layer between the layer on which the first light shielding layer is formed and the layer on which the pixel electrode is formed.

5. The electro-optical device according to claim 1,
wherein the first light shielding film and the second light shielding film are wirings to which a fixed potential is supplied.

6. The electro-optical device according to claim 1,
wherein the outer edge of the first light shielding film and the outer edge of the second light shielding film which define the pixel opening portion are straight lines.

7. An optical unit, comprising:
a first polarizing element which polarizes light in a first direction;
a second polarizing element which polarizes the light in a second direction which intersects the first direction;
the electro-optical device according to claim 1 which is disposed between the first polarizing element and the second polarizing element; and
a light synthesizing optical system which synthesizes and emits the light which is emitted from the plurality of electro-optical devices.

8. An optical unit, comprising:
a first polarizing element which polarizes light in a first direction;
a second polarizing element which polarizes the light in a second direction which intersects the first direction;
the electro-optical device according to claim 2 which is disposed between the first polarizing element and the second polarizing element; and
a light synthesizing optical system which synthesizes and emits the light which is emitted from the plurality of electro-optical devices.

9. An optical unit, comprising:
a first polarizing element which polarizes light in a first direction;
a second polarizing element which polarizes the light in a second direction which intersects the first direction;
the electro-optical device according to claim 3 which is disposed between the first polarizing element and the second polarizing element; and
a light synthesizing optical system which synthesizes and emits the light which is emitted from the plurality of electro-optical devices.

10. An optical unit, comprising:
a first polarizing element which polarizes light in a first direction;
a second polarizing element which polarizes the light in a second direction which intersects the first direction;
the electro-optical device according to claim 4 which is disposed between the first polarizing element and the second polarizing element; and
a light synthesizing optical system which synthesizes and emits the light which is emitted from the plurality of electro-optical devices.

11. An optical unit, comprising:
a first polarizing element which polarizes light in a first direction;
a second polarizing element which polarizes the light in a second direction which intersects the first direction;
the electro-optical device according to claim 5 which is disposed between the first polarizing element and the second polarizing element; and
a light synthesizing optical system which synthesizes and emits the light which is emitted from the plurality of electro-optical devices.

12. An optical unit, comprising:
a first polarizing element which polarizes light in a first direction;
a second polarizing element which polarizes the light in a second direction which intersects the first direction;
the electro-optical device according to claim 6 which is disposed between the first polarizing element and the second polarizing element; and
a light synthesizing optical system which synthesizes and emits the light which is emitted from the plurality of electro-optical devices.

13. An electronic apparatus, comprising:
the electro-optical device according to claim 1.

14. An electronic apparatus, comprising:
the electro-optical device according to claim 2.

15. An electronic apparatus, comprising:
the electro-optical device according to claim 3.

16. An electronic apparatus, comprising:
the electro-optical device according to claim 4.

17. An electronic apparatus, comprising:
the electro-optical device according to claim 5.

18. An electronic apparatus, comprising:
the electro-optical device according to claim 6.

19. An electronic apparatus, comprising:
the optical unit according to claim 7.

20. An electronic apparatus, comprising:
the optical unit according to claim 8.
